(19) United States
(12) Patent Application Publication
(10) Pub. No.: US 2017/0045939 A1
(43) Pub. Date: Feb. 16, 2017

(54) INFORMATION PROCESSING METHOD AND APPARATUS

(71) Applicant: Beijing Zhigu Rui Tuo Tech Co., Ltd, Beijing (CN)

(72) Inventors: Liang ZHOU, Beijing (CN); Hongjiang ZHANG, Beijing (CN)

(73) Assignee: Beijing Zhigu Rui Tuo Tech Co., Ltd, Beijing (CN)

(21) Appl. No.: 15/307,365

(22) PCT Filed: Apr. 16, 2015
(86) PCT No.: PCT/CN2015/076710

§ 371 Date: Oct. 27, 2016

(30) Foreign Application Priority Data
Apr. 28, 2014 (CN) 201410174324.7

(51) Int. Cl. G06F 3/01; G06K 9/00; G06Q 10/10; G06T 1/00

(52) U.S. Cl. CPC G06F 3/013; G06T 1/0007; G06K 9/00456; G06Q 10/109

(57) ABSTRACT

Embodiments of the present application provide an information processing method and apparatus. The method comprises: acquiring a spatial position relationship between a gaze point of a user and an information carrier; and processing, at least according to the spatial position relationship, information carried by the information carrier. The embodiments of the present application provide an information processing solution, to cause that the user can quickly and conveniently select an information process.

### RELATED APPLICATION

The present international patent cooperative treaty (PCT) application claims the benefit of priority to Chinese Patent Application No. 201410174324.7, filed on Apr. 28, 2014, and entitled “Information Processing Method and Apparatus”, which is hereby incorporated into the present international PCT application by reference herein in its entirety.

Technical Field

Embodiments of the present application relate to the field of information technologies, and in particular, to an information processing method and apparatus.

Background

In some occasions, people are made to rapidly process some information. For example, in social occasions, people may establish relationships by exchanging business cards, and generally, received business cards are further classified according to certain categories, for example, information of a received business card is added to address books or one person sends his/her own business card to the other person who he/she received a business card from, and the like.

### SUMMARY

In view of this, an example objective of embodiments of the present application is to provide an information processing solution.

To achieve the foregoing example objective, according to one aspect of the embodiments of the present application, an information processing method is provided, comprising:
acquiring a spatial position relationship between a gaze point of a user and an information carrier; and
processing, at least according to the spatial position relationship, information carried by the information carrier.

To achieve the foregoing example objective, according to another aspect of the embodiments of the present application, an information processing apparatus is provided, comprising:
an acquisition module, configured to acquire a spatial position relationship between a gaze point of a user and an information carrier; and
a processing module, configured to process, at least according to the spatial position relationship, information carried by the information carrier.

At least one of the foregoing technical solutions has the following example beneficial effects:

In an embodiment of the present application, a spatial position relationship between a gaze point of a user and an information carrier is acquired, and information carried by the information carrier is processed at least according to the spatial position relationship, so as to provide an information processing solution, to enable the user to quickly and conveniently select an information processing manner.

### BRIEF DESCRIPTION OF THE DRAWINGS

FIG. 1a is an example schematic flowchart of an embodiment of an information processing method according to the present application;

FIG. 1b is an example schematic flowchart of the embodiment shown in FIG. 1;

FIG. 1c is an example schematic diagram of a spatial position relationship in the embodiment shown in FIG. 1;

FIG. 2a is an example schematic structural diagram of a first embodiment of an information processing apparatus according to the present application;

FIG. 2b to FIG. 2e are respectively example schematic structural diagrams of the embodiment shown in FIG. 2a; and

FIG. 3 is an example schematic structural diagram of a second embodiment of an information processing apparatus according to the present application.

### DETAILED DESCRIPTION

The following further describes example embodiments of the present application in detail with reference to the accompanying drawings and embodiments. The following embodiments are used to describe the present application, but not to limit the scope of the present application.

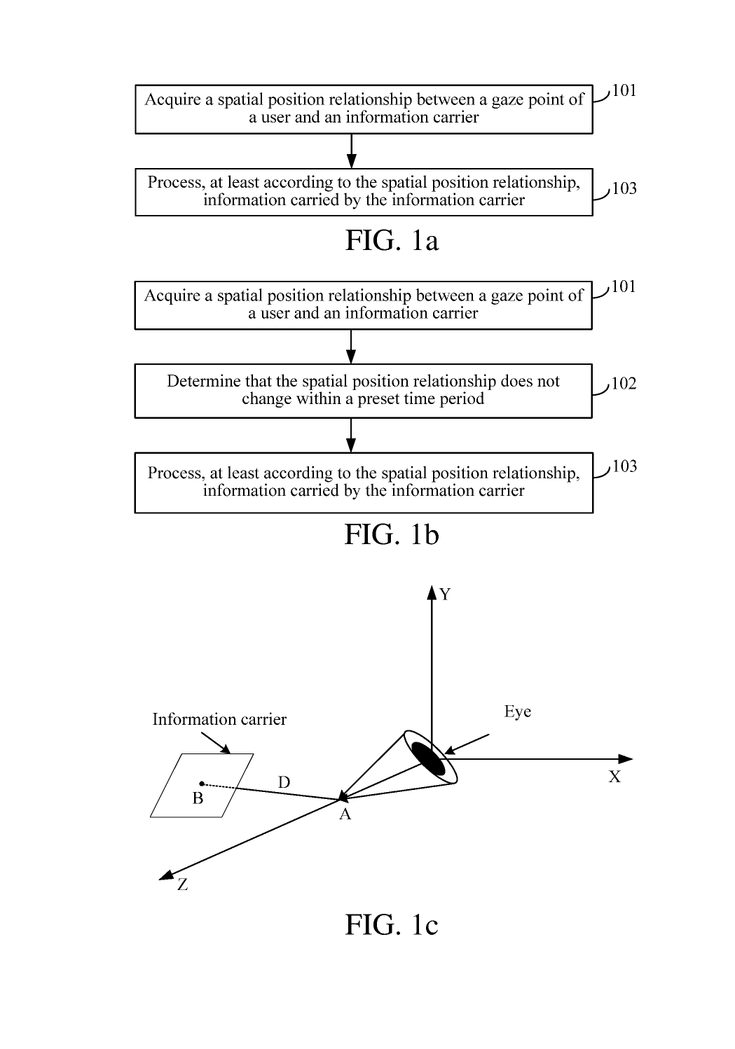

FIG. 1a is a schematic flowchart of an embodiment of an information processing method according to the present application. As shown in FIG. 1a, this embodiment comprises:
101. Acquire a spatial position relationship between a gaze point of a user and an information carrier.

For example, an information processing apparatus provided in the present application is used as an execution body of this embodiment, to perform 101-103. Specifically, the information processing apparatus may be disposed in a user equipment in a manner of software, hardware, or a combination of software and hardware, or the information processing apparatus itself is the user equipment; the user equipment comprises, but is not limited to: smart glasses, and a smart helmet, wherein the smart glasses comprise smart frame glasses and smart contact lenses.

The information carrier in this embodiment may be any object carrying information, and comprises, but is not limited to, any one of the following: a business card, a picture, a label, a two-dimensional code, and a terminal interface. For example, when the business card is used as the information carrier, carried information may comprise a name, a service agency, a position, contact information and the like of the owner of the business card; when the picture is used as the information carrier, carried information may comprise content shown by the picture, and information embedded into the content, such as a watermark; when the label is used as the information carrier, carried information may comprise information about an object that the label is directed to, such as a name, a model, a price and the like of a commodity; when the two-dimensional code is used as the information carrier, carried information may comprise information recorded by the two-dimensional code, such as a website, a business card, text information, and a specific code; and when the terminal interface is used as the information carrier, carried information may comprise content displayed on the interface.

In one optional embodiment, the spatial position relationship comprises at least one of the following: the information carrier overlaps with the gaze point, the information carrier is located above the gaze point, the information carrier is located below the gaze point, the information carrier is located on the left of the gaze point, the information carrier is located on the right of the gaze point, the information carrier is located in front of the gaze point, and the information carrier is located at the back of the gaze point. Optionally, the left, the right, the front, and the back are described relative to the user, for example, if the information carrier is closer to the user than the gaze point, the information carrier is located in front of the gaze point.

For example, one possible scenario is that the information carrier overlaps with the gaze point; another possible scenario is that the information carrier is located in front of the gaze point; another possible scenario is that the information carrier is located in front of and below the gaze point; and another possible scenario is that the information carrier is located in front of, below, and on the right of the gaze point.

In this example embodiment, optionally, the spatial position relationship further comprises: a distance between the information carrier and the gaze point.

In another optional embodiment, the spatial position relationship comprises: a distance between the information carrier and the gaze point. In this example embodiment, the spatial position relationship may not comprise that the information carrier is located above, below, on the left of, on the right of, in front of, or at the back of the gaze point, however, if the distance between the information carrier and the gaze point is 0, it may be considered that the information carrier overlaps with the gaze point.
103. Process, at least according to the spatial position relationship, information carried by the information carrier.

In one optional embodiment, the processing, at least according to the spatial position relationship, information carried by the information carrier comprises:
determining at least one information processing manner corresponding to the spatial position relationship; and
processing, according to the at least one corresponding information processing manner, the information carried by the information carrier.

For example, the information carrier is located above, below, on the left of, on the right of, in front of, or at the back of the gaze point, and the six spatial position relationships respectively correspond to information processing manners 1 to 6. Accordingly, when the spatial position relationship is that the information carrier is located in front of the gaze point, it is determined that the at least one information processing manner corresponding to the spatial position relationship comprises the information processing manner 5; when the spatial position relationship is that the information carrier is located in front of and below the gaze point, it is determined that the at least one information processing manner corresponding to the spatial position relationship comprises the information processing manner 2 and the information processing manner 5; and when the spatial position relationship is that the information carrier is located in front of, below, and on the right of the gaze point, it is determined that the at least one information processing manner corresponding to the spatial position relationship comprises the information processing manner 2, the information processing manner 4, and the information processing manner 5.

For another example, the distance between the information carrier and the gaze point is within [0, 5 cm), [5 cm, 10 cm), [10 cm, 20 cm), or [20 cm, +∞), and the four ranges respectively correspond to information processing manners A, B, C, and D. Accordingly, when the spatial position relationship is that the distance between the information carrier and the gaze point is 2 cm, it is determined that the at least one information processing manner corresponding to the spatial position relationship comprises the information processing manner A; and when the spatial position relationship is that the distance between the information carrier and the gaze point is 12 cm, it is determined that the at least one information processing manner corresponding to the spatial position relationship comprises the information processing manner C.

For another example, the information carrier is located above, below, on the left of, on the right of, in front of, or at the back of the gaze point, and the six spatial position relationships respectively correspond to information processing manners 1 to 6; the distance between the information carrier and the gaze point is within [0, 5 cm), [5 cm, 10 cm), [10 cm, 20 cm), or [20 cm, +∞), and the four ranges respectively correspond to information processing manners A, B, C, and D. Accordingly, when the spatial position relationship is that the information carrier is located in front of and below the gaze point and the distance between the information carrier and the gaze point is 8 cm, it is determined that the at least one information processing manner corresponding to the spatial position relationship comprises the information processing manner 2, the information processing manner 5, and the information processing manner B.

In order to help a user to select an appropriate information processing manner, further optionally, after the determining at least one information processing manner corresponding to the spatial position relationship, the method further comprises:
prompting the user the at least one corresponding information processing manner.

There are many prompting manners, comprising, but not limited to: auditory prompts, and visual prompts.

Optionally, the prompting the user the at least one corresponding information processing manner comprises: displaying the at least one corresponding information processing manner at the gaze point.

Optionally, the information processing apparatus may complete the displaying through a built-in near-eye display or by invoking an external near-eye display. Optionally, the displaying in this embodiment is transmissive displaying, that is, the user can see, through displayed content, an object around the content, such as, the information carrier.

Optionally, at least one information processing manner corresponding to another spatial position relationship may also be prompted to the user.

Optionally, before the determining at least one information processing manner corresponding to the spatial position relationship, this embodiment further comprises:
determining the information carried by the information carrier;
determining at least one information processing manner corresponding to the information; and
determining a correspondence between the at least one information processing manner corresponding to the information and at least one spatial position relationship.

Usually, different types of information may correspond to different information processing manners. For example, for the information carried by the business card, such as a name, a service agency, a position, and contact information, there may be information processing manners such as adding the information to an address book, returning his/her own business card, searching for and following the information in social networks; and for the information carried by the two-dimensional code, for example, a website, there may be information processing manners such as opening a webpage and adding the website to favorites.

The correspondence may be one to one, one to more, or more to one, which is not limited in this embodiment. For example, for the information carried by the business card, such as a name, a service agency, a position, and contact information, there may be three corresponding information processing manners, for example, adding the information to an address book, returning his/her own business card, searching for and following the information in social networks; one possible scenario is that the distance between the information carrier and the gaze point is grouped into three ranges, that is, three spatial position relationships, the three spatial position relationships may correspond to the three information processing manners in a one-to-one manner, or, each spatial position relationship respectively corresponds to one or more of the three information processing manners, and certainly, it is possible that at least one spatial position relationship does not correspond to any information processing manner. Optionally, when the spatial position relationship acquired in 101 does not correspond to any information processing manner, no information processing may be performed on the information carried by the information carrier.

To sum up, in a scenario in which the information carried by the information carrier is different, information processing manners corresponding to the same spatial position relationship may also be different.

In one optional embodiment, considering that the spatial position relationship may change, for example, the spatial position relationship may change in a process that the user holds and moves the information carrier to adjust the spatial position relationship, in order to avoid incorrect operations, optionally, as shown in FIG. 1b, before 103, the method further comprises:
102. Determine that the spatial position relationship does not change within a preset time period.

The preset time period may be set by the user, for example, set to 2 seconds. In some scenarios, even if a spatial position of the information carrier changes, the spatial position relationship may not change. For example, if the spatial position relationship is that the distance between the information carrier and the gaze point is within a range of [0, 5 cm), even if the position of the information carrier or the gaze point changes, it can be determined that the spatial position relationship does not change as long as the distance between the information carrier and the gaze point is kept within the range of [0, 5 cm).

In one possible scenario, the information carrier is a business card; and the processing information carried by the information carrier comprises any one of the following:
collecting an image of the business card;
collecting an image of the business card, and identifying and storing the image;
collecting an image of the business card, identifying and storing the image, and sending information according to an identified communication identifier; and
collecting an image of the business card, identifying and storing the image, and performing a social operation according to an identified user identifier.

Specifically, each processing may correspond to one or more information processing manners. For example, collecting an image of the business card is one information processing manner, and identifying and storing the image is another information processing manner; or, collecting an image of the business card is one information processing manner, and collecting an image of the business card and identifying and storing the image is another information processing manner.

Identifying the image may be identifying the information carried by the business card; the storing may be adding the information carried by the business card to an address book; the communication identifier may be a mobile phone number, an e-mail address, or the like, and accordingly, sending information according to an identified communication identifier may be sending information to the mobile phone number through a short message service message or a multimedia messaging service message or sending information to the e-mail address in a form of an e-mail, and the information may specifically be a business card of the user or the like; the user identifier may be a name, a social network user name, or the like, and accordingly, performing a social operation according to an identified user identifier may be searching for the name or the social network user name in a social network, and following a searched user or adding a searched user as a friend or the like.

It is noted that, in the example embodiment of prompting the information processing manner, brief introduction of the information processing manner or a corresponding user category may be prompted. For example, for the processing manner of “collecting an image of the business card”, “photograph” may be prompted, and for the information processing manner of “collecting an image of the business card, and identifying and storing the image”, “add to an address book” may be prompted. For another example, for the information processing manner of “collecting an image of the business card, and identifying and storing the image”, “persons I may contact” may be prompted; for the information processing manner of “collecting an image of the business card, identifying and storing the image, and sending information according to an identified communication identifier”, “persons I want to know” may be prompted; and for “collecting an image of the business card, identifying and storing the image, and performing a social operation according to an identified user identifier”, “persons with similar interests” may be prompted. The prompts are equivalent to classifications of the business card by the user, which facilitates rapid classification of business cards in social occasions and avoids delaying important dialogues or missing important information that is caused by the fact that the business cards are organized afterwards.

FIG. 1c is a schematic diagram of a spatial position relationship in this embodiment. As shown in FIG. 1c, in a three-dimensional coordinate in which an eye of the user is used as the origin of the coordinates, the gaze point of the user is located at point A of Z axis, the center of the business card is located at point B, and the information carried by the business card, for example, comprises: Zhang San, general manager of 123 Company, phone number, and e-mail address; a distance D between point A and point B is grouped into five ranges, namely, [0, 5 cm), [5 cm, 10 cm), [10 cm, 15 cm), [15 cm, 20 cm), and [20 cm, +∞), wherein an information processing manner corresponding to [20 cm, +∞) is that no processing is performed; an information processing manner corresponding to [15 cm, 20 cm) is collecting an image of the business card, that is, the business card is saved in a form of a picture; an information processing manner corresponding to [10 cm, 15 cm) is collecting an image of the business card, identifying and storing the image and sending a first business card of the user to an identified e-mail address; an information processing manner corresponding to [5 cm, 10 cm) is collecting an image of the business card, identifying and storing the image and sending a second business card of the user to an identified e-mail address; and an information processing manner corresponding to [0, 5 cm) is collecting an image of the business card, identifying and storing the image, searching for “Zhang San” and/or “123 Company” in a social network, and following the searched user, wherein information carried by the first business card of the user may be different from that carried by the second business card of the user, for example, the first business card does not comprise a direct-dial phone number of the user, while the second business card comprises a direct-dial telephone number of the user. It is noted that, before 101, there is generally an object at point A guiding the gaze point of the user to point A, wherein the object may be any entity, such as the face of an object that the user is talking with or a handheld device of the user, or may be a window which a near-eye display is projected, and optionally, information processing manners corresponding to various spatial position relationships may be displayed in the window.

One possible scenario is that, first, the user places a business card at point B which is at a distance D being more than 20 cm from point A, and in this case, an information processing manner corresponding to a range of the distance D is displayed at point A; then, the user moves the business card to a direction close to the user, wherein when the distance D is within the range of [15 cm, 20 cm), an information processing manner corresponding to the range of the current distance D is displayed at point A, and if the user wants the information processing manner, the user keeps the business card stay at the current point B for a period of time, to cause that the information processing apparatus processes, according to the corresponding information processing manner, the information carried by the business card. Another possible scenario is that, first, the user places a business card at point B which is at a distance D being more than 20 cm from point A, and in this case, information processing manners corresponding to various distance ranges are displayed at point A and an information processing manner corresponding to the range of the current distance D is highlighted; then, the user moves the business card according to a desired information processing manner, for example, moves the business card to a point which is at a distance D in a range of [0, 5 cm) from point A, and in this case, the information processing manners corresponding to various distance ranges are displayed at point A and the information processing manner corresponding to [0, 5 cm) is highlighted, and the user keeps the business card stay at the current point B for a period of time, to cause that the information processing apparatus processes, according to the corresponding information processing manner, the information carried by the business card. In either one of the foregoing scenarios, the user can rapidly and conveniently select a processing manner for the business card without affecting the original activity of the user, for example, social communication with others.

In this embodiment, a spatial position relationship between a gaze point of a user and an information carrier is acquired, and information carried by the information carrier is processed at least according to the spatial position relationship, so as to provide an information processing solution, to cause that the user can quickly and conveniently select an information processing manner.

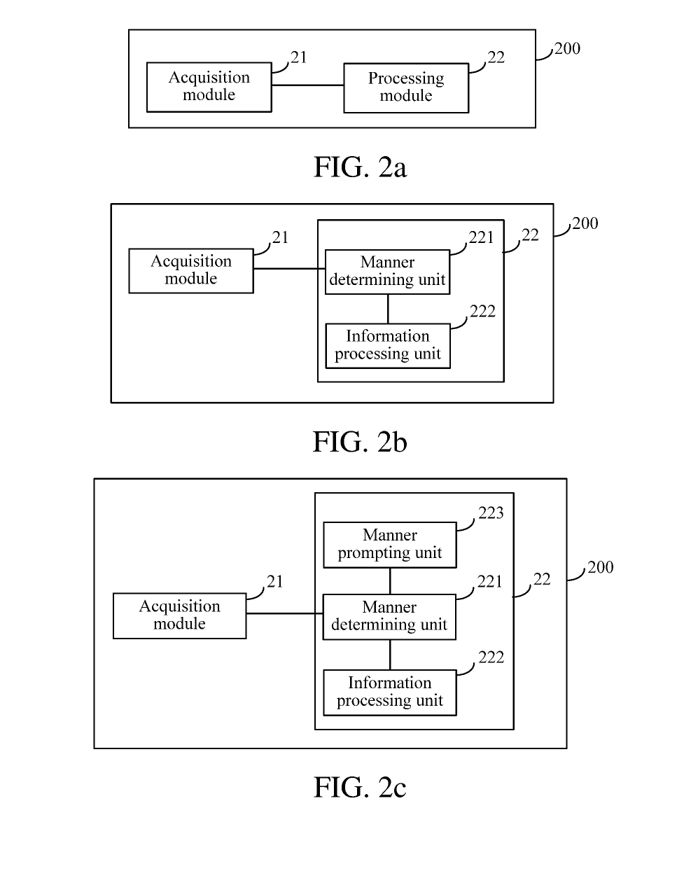

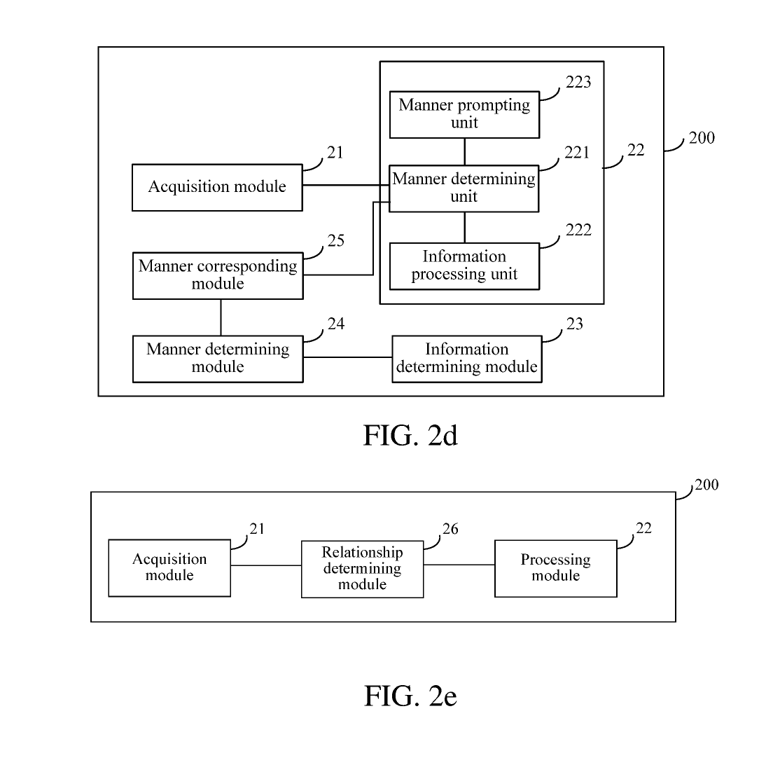

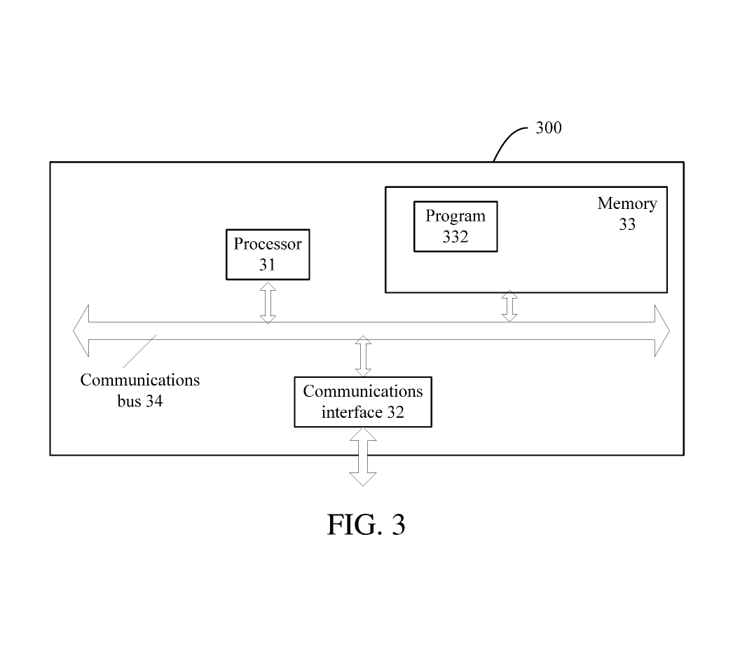

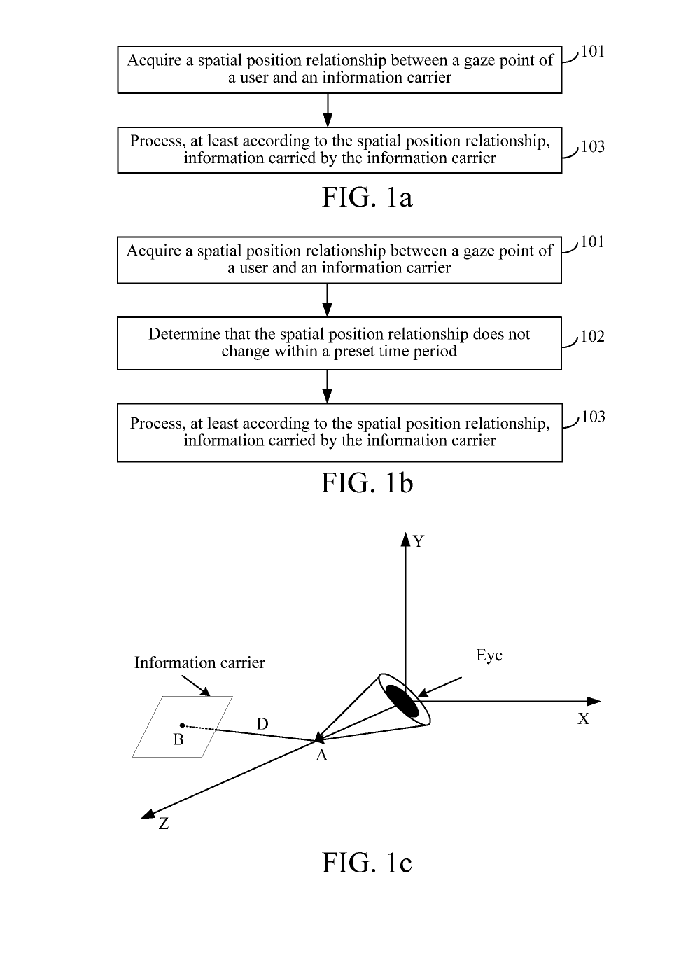

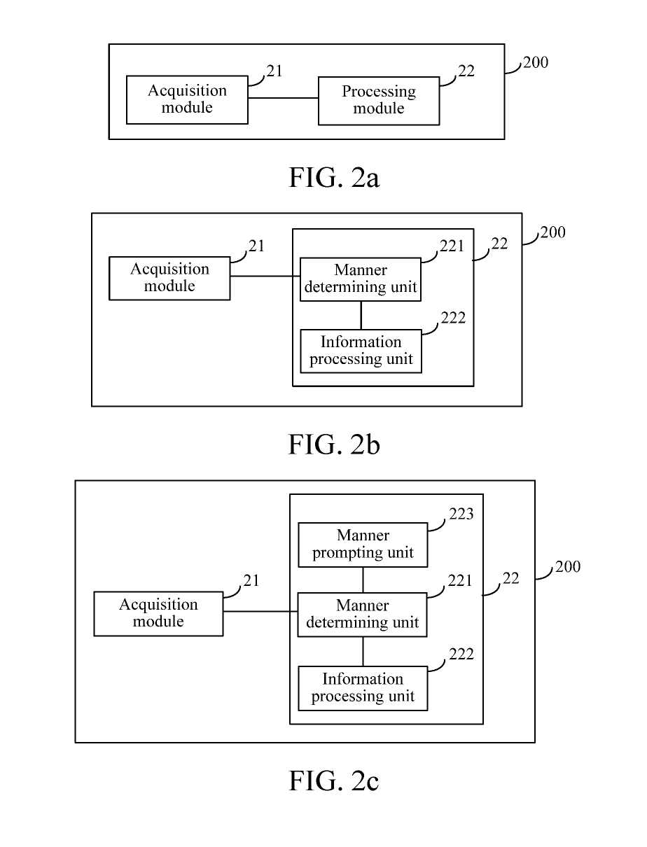

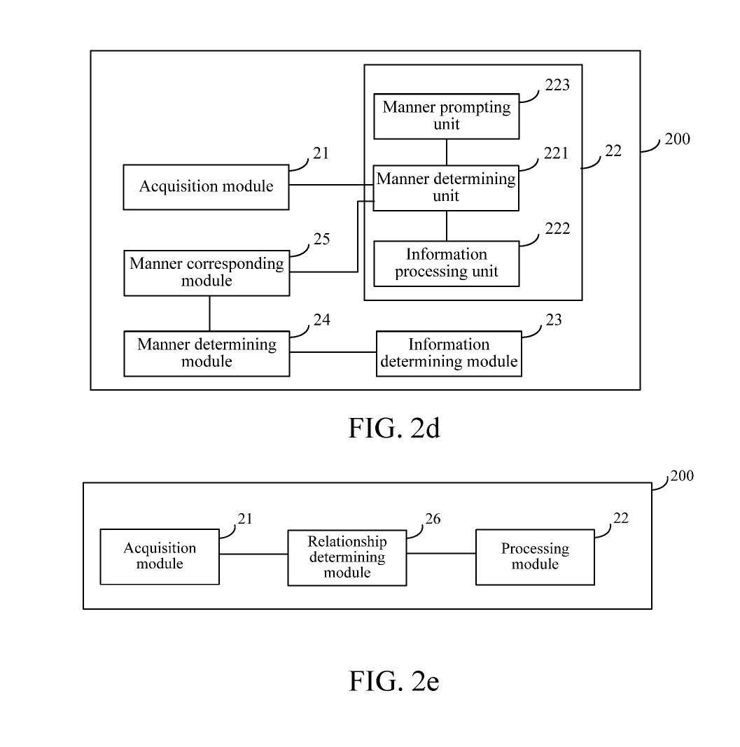

FIG. 2a is a schematic structural diagram of a first embodiment of an information processing apparatus according to the present application. As shown in FIG. 2a, the information processing apparatus 200 (hereinafter briefly referred to as: the apparatus 200) comprises:

an acquisition module 21, configured to acquire a spatial position relationship between a gaze point of a user and an information carrier; and a processing module 22, configured to process, at least according to the spatial position relationship, information carried by the information carrier.

The information carrier in this embodiment may be any object carrying information, and comprises, but is not limited to, any one of the following: a business card, a picture, a label, a two-dimensional code, and a terminal interface. For example, when the business card is used as the information carrier, carried information may comprise a name, a service agency, a position, contact information and the like of the owner of the business card; when the picture is used as the information carrier, carried information may comprise content shown by the picture, and information embedded into the content, such as a watermark; when the label is used as the information carrier, carried information may comprise information about an object that the label is directed to, such as a name, a model, a price and the like of a commodity; when the two-dimensional code is used as the information carrier, carried information may comprise information recorded by the two-dimensional code, such as a website, a business card, text information, and a specific code; and when the terminal interface is used as the information carrier, carried information may comprise content displayed on the interface.

In one optional embodiment, the spatial position relationship comprises at least one of the following: the information carrier overlaps with the gaze point, the information carrier is located above the gaze point, the information carrier is located below the gaze point, the information carrier is located on the left of the gaze point, the information carrier is located on the right of the gaze point, the information carrier is located in front of the gaze point, and the information carrier is located at the back of the gaze point. Optionally, the left, the right, the front, and the back are described relative to the user, for example, if the information carrier is closer to the user than the gaze point, the information carrier is located in front of the gaze point.

For example, one possible scenario is that the information carrier overlaps with the gaze point; another possible scenario is that the information carrier is located in front of the gaze point; another possible scenario is that the information carrier is located in front of and below the gaze point; and another possible scenario is that the information carrier is located in front of, below, and on the right of the gaze point.

In this example embodiment, optionally, the spatial position relationship further comprises: a distance between the information carrier and the gaze point.

In another optional embodiment, the spatial position relationship comprises: a distance between the information carrier and the gaze point. In this example embodiment, the spatial position relationship may not comprise that the information carrier is located above, below, on the left of, on the right of, in front of, or at the back of the gaze point, however, if the distance between the information carrier and the gaze point is 0, it may be considered that the information carrier overlaps with the gaze point.

In one optional embodiment, as shown in FIG. 2b, the processing module 22 comprises:
a manner determining unit 221, configured to determine at least one information processing manner corresponding to the spatial position relationship; and
an information processing unit 222, configured to process, according to the at least one corresponding information processing manner, the information carried by the information carrier.

For example, the information carrier is located above, below, on the left of, on the right of, in front of, or at the back of the gaze point, and the six spatial position relationships respectively correspond to information processing manners 1 to 6. Accordingly, when the spatial position relationship is that the information carrier is located in front of the gaze point, the manner determining unit 221 determines that the at least one information processing manner corresponding to the spatial position relationship comprises the information processing manner 5; when the spatial position relationship is that the information carrier is located in front of and below the gaze point, the manner determining unit 221 determines that the at least one information processing manner corresponding to the spatial position relationship comprises the information processing manner 2 and the information processing manner 5; and when the spatial position relationship is that the information carrier is located in front of, below, and on the right of the gaze point, the manner determining unit 221 determines that the at least one information processing manner corresponding to the spatial position relationship comprises the information processing manner 2, the information processing manner 4, and the information processing manner 5.

For another example, the distance between the information carrier and the gaze point is within [0, 5 cm), [5 cm, 10 cm), [10 cm, 20 cm), or [20 cm, +∞), and the four ranges respectively correspond to information processing manners A, B, C, and D. Accordingly, when the spatial position relationship is that the distance between the information carrier and the gaze point is 2 cm, the manner determining unit 221 determines that the at least one information processing manner corresponding to the spatial position relationship comprises the information processing manner A; and when the spatial position relationship is that the distance between the information carrier and the gaze point is 12 cm, the manner determining unit 221 determines that the at least one information processing manner corresponding to the spatial position relationship comprises the information processing manner C.

For another example, the information carrier is located above, below, on the left of, on the right of, in front of, or at the back of the gaze point, and the six spatial position relationships respectively correspond to information processing manners 1 to 6; the distance between the information carrier and the gaze point is within [0, 5 cm), [5 cm, 10 cm), [10 cm, 20 cm), or [20 cm, +∞), and the four ranges respectively correspond to information processing manners A, B, C, and D. Accordingly, when the spatial position relationship is that the information carrier is located in front of and below the gaze point and the distance between the information carrier and the gaze point is 8 cm, the manner determining unit 221 determines that the at least one information processing manner corresponding to the spatial position relationship comprises the information processing manner 2, the information processing manner 5, and the information processing manner B.

In order to help a user to select an appropriate information processing manner, as shown in FIG. 2c, optionally, the processing module 22 further comprises: a manner prompting unit 223, configured to prompt the user the at least one corresponding information processing manner.

There are many prompting manners in which the manner prompting unit 223 prompts the user, comprising, but not limited to: auditory prompts, and visual prompts.

Optionally, the manner prompting unit 223 is specifically configured to display the at least one corresponding information processing manner at the gaze point.

Specifically, the manner prompting unit 223 may complete the displaying through a built-in near-eye display of the apparatus 200 or by invoking an external near-eye display. Optionally, the displaying in this embodiment is transmissive displaying, that is, the user can see, through displayed content, an object around the content, such as, the information carrier.

Optionally, the manner prompting unit 223 may also prompt the user at least one information processing manner corresponding to another spatial position relationship.

Optionally, as shown in FIG. 2d, the apparatus 200 further comprises:
an information determining module 23, configured to determine the information carried by the information carrier;
a manner determining module 24, configured to determine at least one information processing manner corresponding to the information; and
a manner corresponding module 25, configured to determine a correspondence between the at least one information processing manner corresponding to the information and at least one spatial position relationship.

Usually, different types of information may correspond to different information processing manners. For example, for the information carried by the business card, such as a name, a service agency, a position, and contact information, there may be information processing manners such as adding the information to an address book, returning his/her own business card, searching for and following the information in social networks; and for the information carried by the two-dimensional code, for example, a website, there may be information processing manners such as opening a webpage and adding the website to favorites.

The correspondence determined by the manner corresponding module 25 may be one to one, one to more, or more to one, which is not limited in this embodiment. For example, for the information carried by the business card, such as a name, a service agency, a position, and contact information, there may be three information processing manners, for example, adding the information to an address book, returning his/her own business card, searching for and following the information in social networks. One possible scenario is that the distance between the information carrier and the gaze point is grouped into three ranges, that is, three spatial position relationships, the manner corresponding module 25 may make the three spatial position relationships correspond to the three information processing manners in a one-to-one manner, or, make each spatial position relationship respectively correspond to one or more of the three information processing manners, and certainly, it is possible that at least one spatial position relationship does not correspond to any information processing manner. Optionally, when the manner determining unit 221 determines that the spatial position relationship acquired by the acquisition module 21 does not correspond to any information processing manner, the information processing unit 222 may perform no information processing on the information carried by the information carrier.

To sum up, in a scenario in which the information carried by the information carrier is different, information processing manners corresponding to the same spatial position relationship may also be different.

In one optional embodiment, considering that the spatial position relationship may change, for example, the spatial position relationship may change in a process that the user holds and moves the information carrier to adjust the spatial position relationship, in order to avoid incorrect operations, optionally, as shown in FIG. 2e, the apparatus 200 further comprises:
a relationship determining module 26, configured to determine that the spatial position relationship does not change within a preset time period.

The preset time period may be set by the user, for example, set to 2 seconds. In some scenarios, even if a spatial position of the information carrier changes, the spatial position relationship may not change. For example, if the spatial position relationship is that the distance between the information carrier and the gaze point is within a range of [0, 5 cm), even if the position of the information carrier or the gaze point changes, the relationship determining module 26 can determine that the spatial position relationship does not change as long as the distance between the information carrier and the gaze point is kept within the range of [0, 5 cm).

In one possible scenario, the information carrier is a business card; and the processing module 22 is specifically configured to perform any one of the following processing on the information carried by the information carrier:
collecting an image of the business card;
collecting an image of the business card, and identifying and storing the image;
collecting an image of the business card, identifying and storing the image, and sending information according to an identified communication identifier; and
collecting an image of the business card, identifying and storing the image, and performing a social operation according to an identified user identifier.

Specifically, each processing performed by the processing module 22 may correspond to one or more information processing manners. For example, collecting an image of the business card is one information processing manner, and identifying and storing the image is another information processing manner; or, collecting an image of the business card is one information processing manner, and collecting an image of the business card and identifying and storing the image is another information processing manner.

Identifying the image may be identifying the information carried by the business card; the storing may be adding the information carried by the business card to an address book; the communication identifier may be a mobile phone number, an e-mail address, or the like, and accordingly, sending information according to an identified communication identifier may be sending information to the mobile phone number through a short message service message or a multimedia messaging service message or sending information to the e-mail address in a form of an e-mail, and the information may specifically be a business card of the user or the like; the user identifier may be a name, a social network user name, or the like, and accordingly, performing a social operation according to an identified user identifier may be searching for the name or the social network user name in a social network, and following him or her or adding him or her as a friend or the like.

It is noted that, in the example embodiment of prompting the information processing manner, the manner prompting unit 223 may prompt brief introduction of the information processing manner or a corresponding user category. For example, for the processing manner of “collecting an image of the business card”, the manner prompting unit 223 may prompt “photograph”, and for the information processing manner of “collecting an image of the business card, and identifying and storing the image”, the manner prompting unit 223 may prompt “add to an address book”. For another example, for the information processing manner of “collecting an image of the business card, and identifying and storing the image”, the manner prompting unit 223 may prompt “persons I may contact”; for the information processing manner of “collecting an image of the business card, identifying and storing the image, and sending information according to an identified communication identifier”, the manner prompting unit 223 may prompt “persons I want to know”; and for “collecting an image of the business card, identifying and storing the image, and performing a social operation according to an identified user identifier”, the manner prompting unit 223 may prompt “persons with similar interests”. The prompts are equivalent to classifications of the business card by the user, which facilitates rapid classification of business cards in social occasions and avoids delaying important dialogues or missing important information that is caused by the fact that the business cards are organized afterwards.

FIG. 1c is a schematic diagram of a spatial position relationship in this embodiment. As shown in FIG. 1c, in a three-dimensional coordinate in which an eye of the user is used as the origin of the coordinates, the gaze point of the user is located at point A of Z axis, the center of the business card is located at point B, and the information carried by the business card, for example, comprises: Zhang San, general manager of 123 Company, phone number, and e-mail address; a distance D between point A and point B is grouped into five ranges, namely, [0, 5 cm), [5 cm, 10 cm), [10 cm, 15 cm), [15 cm, 20 cm), and [20 cm, +∞), wherein an information processing manner corresponding to [20 cm, +∞) is that no processing is performed; an information processing manner corresponding to [15 cm, 20 cm) is collecting an image of the business card, that is, the business card is saved in a form of a picture; an information processing manner corresponding to [10 cm, 15 cm) is collecting an image of the business card, identifying and storing the image and sending a first business card of the user to an identified e-mail address; an information processing manner corresponding to [5 cm, 10 cm) is collecting an image of the business card, identifying and storing the image and sending a second business card of the user to an identified e-mail address; and an information processing manner corresponding to [0, 5 cm) is collecting an image of the business card, identifying and storing the image, searching for “Zhang San” and/or “123 Company” in a social network, and following the searched user, wherein information carried by the first business card of the user may be different from that carried by the second business card of the user, for example, the first business card does not comprise a direct-dial phone number of the user, while the second business card comprises a direct-dial telephone number of the user. It is noted that, before the acquisition module 21 acquires the spatial position relationship between the gaze point of the user and the information carrier, there is generally an object at point A guiding the gaze point of the user to point A, wherein the object may be any entity, such as the face of an object that the user is talking with or a handheld device of the user, or may be a window which a near-eye display is projected, and optionally, information processing manners corresponding to various spatial position relationships can be displayed in the window. Optionally, the apparatus 200 further comprises: a display module, configured to display a window, so as to guide the gaze point of the user to the window.

One possible scenario is that, first, the user places a business card at point B which is at a distance D being more than 20 cm from point A, and in this case, the manner prompting unit 223 displays an information processing manner corresponding to the range of the distance D at point A; then, the user moves the business card to a direction close to the user, wherein when the distance D is within the range of [15 cm, 20 cm), the acquisition module 21 acquires the spatial position relationship, the manner prompting unit 223 displays an information processing manner corresponding to the range of the current distance D at point A, and if the user wants the information processing manner, the user keeps the business card stay at the current point B for a period of time, to cause that the information processing unit 222 processes, according to the corresponding information processing manner, the information carried by the business card. Another possible scenario is that, first, the user places a business card at point B which is at a distance D being more than 20 cm from point A, the acquisition module 21 acquires the spatial position relationship, the manner prompting unit 223 displays information processing manners corresponding to various distance ranges at point A and highlights an information processing manner corresponding to the range of the current distance D; then, the user moves the business card according to a desired information processing manner, for example, moves the business card to point which is at a distance D in a range of [0, 5 cm) from point A, the acquisition module 21 acquires the spatial position relationship, the manner prompting unit 223 displays the information processing manners corresponding to various distance ranges at point A and highlights the information processing manner corresponding to [0, 5 cm), and the user keeps the business card stay at the current point B for a period of time, to cause that the information processing unit 222 processes, according to the corresponding information processing manner, the information carried by the business card. In either one of the foregoing scenarios, the user can rapidly and conveniently select a processing manner for the business card without affecting the original activity of the user, for example, social communication with others.

Specifically, the apparatus 200 in this embodiment may be disposed in a user equipment in a manner of software, hardware, or a combination of software and hardware, or the apparatus 200 itself is the user equipment; the user equipment comprises, but is not limited to: a smart phone, smart glasses, and a smart helmet, wherein the smart glasses comprise smart frame glasses and smart contact lenses.

For example, the apparatus 200 is smart frame glasses, and the smart frame glasses may acquire a gaze point of a user and a spatial position of an information carrier through a camera, so as to acquire a spatial position relationship between the gaze point and the information carrier, and process, at least according to the spatial position relationship, information carried by the information carrier. For another example, the apparatus 200 is a smart phone, and the smart phone can acquire a spatial position of a gaze point of a user by using smart glasses connected to the smart phone, acquire a spatial position of an information carrier by using an external or a built-in positioning apparatus, so as to acquire a spatial position relationship between the gaze point and the information carrier, and process, at least according to the spatial position relationship, information carried by the information carrier.

In this embodiment, an acquisition module acquires a spatial position relationship between a gaze point of a user and an information carrier, and a processing module processes, at least according to the spatial position relationship, information carried by the information carrier, so as to provide an information processing solution, to cause that the user can quickly and conveniently select an information processing manner.

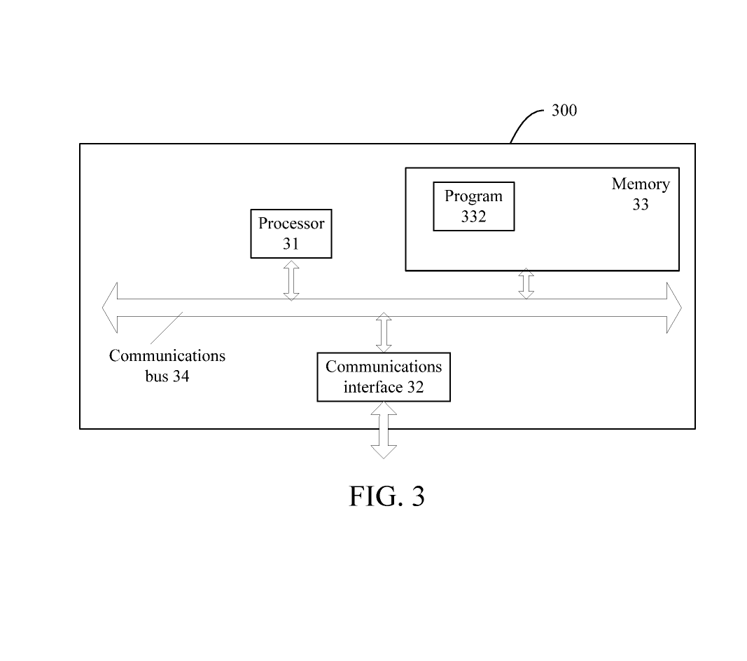

FIG. 3 is a schematic structural diagram of a second embodiment of an information processing apparatus according to the present application. As shown in FIG. 3, an information processing apparatus 300 comprises:
a processor 31, a communications interface 32, a memory 33, and a communications bus 34.

The processor 31, the communications interface 32, and the memory 33 communicate with each other by using the communications bus 34.

The communications interface 32 is configured to communicate with an external device.

The processor 31 is configured to execute a program 332, and specifically, may implement relevant steps in the embodiments of the information processing methods.

Specifically, the program 332 may comprise program code, wherein the program code comprises a computer operation instruction.

The processor 31 may be a central processing unit (CPU), or an application specific integrated circuit (ASIC), or one or more integrated circuits configured to implement the embodiments of the information processing methods.

The memory 33 is configured to store the program 332. The memory 33 may comprise a high-speed random access memory (RAM), or may also comprise a non-volatile memory, for example, at least one magnetic disk memory. The program 332 may be specifically configured to enable the information processing apparatus 300 to perform the following steps:
acquiring a spatial position relationship between a gaze point of a user and an information carrier; and
processing, at least according to the spatial position relationship, information carried by the information carrier.

For specific implementation of the steps in the program 332, reference may be made to corresponding description in the corresponding steps and units in the embodiments of the information processing methods, and no further details are provided herein again. A person skilled in the art may clearly know that, for the purpose of convenient and brief description, for a detailed working process of the foregoing device and modules, reference may be made to a corresponding process in the foregoing embodiments of the foregoing information processing methods, and no further details are provided herein again.

A person of ordinary skill in the art may be aware that, with reference to the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present embodiments.

When the functions are implemented in a form of a software functional unit and sold or used as an independent product, the functions may be stored in a computer-readable storage medium. Based on such an understanding, the technical solutions of the various embodiments essentially, or the part contributing to the prior art, or a part of the technical solutions may be implemented in a form of a software product. The computer software product is stored in a storage medium, and comprises several instructions for instructing a computer device (which may be a personal computer, a server, a network device, or the like) to perform all or a part of the steps of the methods described in the embodiments of the present application. The foregoing storage medium comprises: any medium that can store program code, such as a USB flash drive, a removable hard disk, a read-only memory (ROM, Read-Only Memory), a RAM, a magnetic disk, or an optical disc.

The foregoing example embodiments are merely used for describing the various embodiments, rather than limiting the embodiments. A person of ordinary skill in the art may made various changes and modifications without departing from the spirit and scope of the various embodiments, and therefore, all equivalent technical solutions shall belong to the scope of the various embodiments, and the protection scope of the present application shall be subject to the claims.

What is claimed is:

1. A method, comprising:
acquiring, by a system comprising a processor, a spatial position relationship between a gaze point of a user and an information carrier; and
processing, at least according to the spatial position relationship, information carried by the information carrier.

2. The method of claim 1, wherein the spatial position relationship comprises at least one of the information carrier overlaps with the gaze point, the information carrier is located above the gaze point, the information carrier is located below the gaze point, the information carrier is located left of the gaze point, the information carrier is located right of the gaze point, the information carrier is located in front of the gaze point, or the information carrier is located behind the gaze point.

3. The method of claim 1, wherein the spatial position relationship comprises: a distance between the information carrier and the gaze point.

4. The method of claim 1, wherein the processing, at least according to the spatial position relationship, the information carried by the information carrier comprises:
determining at least one information process corresponding to the spatial position relationship; and
processing, according to the at least one information process, the information carried by the information carrier.

5. The method of claim 4, wherein, after the determining the at least one information process corresponding to the spatial position relationship, the method further comprises:
prompting the user regarding the at least one corresponding information process.

6. The method of claim 5, wherein the prompting the user regarding the at least one corresponding information process comprises:
displaying the at least one corresponding information process at the gaze point.

7. The method of claim 4, wherein, before the determining at least one information process corresponding to the spatial position relationship, the method further comprises:
determining the information carried by the information carrier;
determining at least one information process corresponding to the information; and
determining a correspondence between the at least one information process corresponding to the information and at least one spatial position relationship.

8. The method of claim 1, wherein, before the processing, at least according to the spatial position relationship, the information carried by the information carrier, the method further comprises:
determining that the spatial position relationship does not change within a preset time period.

9. The method of claim 1, wherein the information carrier comprises at least one of a business card, a picture, a label, a two-dimensional code, or a terminal interface.

10. The method of claim 9, wherein the information carrier is a business card; and the processing information carried by the information carrier comprises at least one of:
collecting an image of the business card;
collecting the image of the business card, and identifying and storing the image;
collecting the image of the business card, identifying and storing the image, and sending information according to an identified communication identifier; or
collecting the image of the business card, identifying and storing the image, and performing a social operation according to an identified user identifier.

11. An apparatus, comprising:
a memory that stores executable modules; and
a processor, coupled to the memory, that executes or facilitates execution of the executable modules, comprising:
an acquisition module configured to acquire a spatial position relationship between a gaze point of a user and an information carrier; and
a processing module configured to process, at least according to the spatial position relationship, information carried by the information carrier.

12. The apparatus of claim 11, wherein the spatial position relationship comprises at least one of the information carrier overlaps with the gaze point, the information carrier is located above the gaze point, the information carrier is located below the gaze point, the information carrier is located left of the gaze point, the information carrier is located right of the gaze point, the information carrier is located in front of the gaze point, and the information carrier is located behind the gaze point.

13. The apparatus of claim 11, wherein the spatial position relationship comprises: a distance between the information carrier and the gaze point.

14. The apparatus of claim 11, wherein the processing module comprises:
a manner determining unit configured to determine at least one information process corresponding to the spatial position relationship; and
an information processing unit configured to process, according to the at least one information process, the information carried by the information carrier.

15. The apparatus of claim 14, wherein the processing module further comprises: a manner prompting unit configured to prompt the user relating to the at least one information process.

16. The apparatus of claim 15, wherein the manner prompting unit is further configured to:
display the at least one information process at the gaze point.

17. The apparatus of claim 14, wherein the executable modules further comprise:
an information determining module configured to determine the information carried by the information carrier;
a manner determining module configured to determine at least one information process corresponding to the information; and
a manner corresponding module configured to determine a correspondence between the at least one information process corresponding to the information and at least one spatial position relationship.

18. The apparatus of claim 11, wherein the executable modules further comprises:
a relationship determining module configured to determine that the spatial position relationship does not change within a preset time period.

19. The apparatus of claim 11, wherein the information carrier comprises any one of a business card, a picture, a label, a two-dimensional code, or a terminal interface.

20. The apparatus of claim 19, wherein the information carrier is the business card; and the processing module is further configured to perform, on the information carried by the information carrier, any one of:
collecting an image of the business card;
collecting the image of the business card, and identifying and storing the image;
collecting the image of the business card, identifying and storing the image, and sending information according to an identified communication identifier; and
collecting the image of the business card, identifying and storing the image, and performing a social operation according to an identified user identifier.

21. A computer readable storage device comprising executable instructions that, in response to execution, cause a device comprising a processor to perform operations, comprising:
acquiring a spatial position relationship between a gaze point of a user identity and an information carrier; and
processing, at least according to the spatial position relationship, information carried by the information carrier.
